(19) United States
(12) Patent Application Publication
(10) Pub. No.: US 2008/0115423 A1
(43) Pub. Date: May 22, 2008

(54) Polishing Composition For Silicon Wafer

(75) Inventors: Yoshiyuki Kashima, Chiba (JP); Masaaki Ohshima, Chiba (JP); Eiichirou Ishimizu, Chiba (JP); Naohiko Suemura, Chiba (JP)

Correspondence Address: OLIFF & BERRIDGE, PLC, P.O. BOX 320850, ALEXANDRIA, VA, 22320-4850, US

(73) Assignee: NISSAN CHEMICAL INDUSTRIES, LTD., CHIYODA-KU TOKYO (JP)

(21) Appl. No.: 11/662,804

(22) PCT Filed: Oct. 27, 2005
(86) PCT No.: PCT/JP05/19782

§ 371 Date: Apr. 2, 2007

(30) Foreign Application Priority Data
Oct. 28, 2004 (JP) 2004-313174
Jan. 27, 2005 (JP) 2005-019102

(51) Int. Cl. C09K 3/14

(52) U.S. Cl. 51/308; 977/902

(57) ABSTRACT

The present invention relates to a polishing composition for silicon wafer comprising silica; a basic compound; at least one compound selected from the group consisting of amino acid derivatives represented by formula (1)

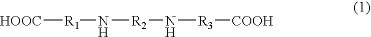

wherein R₁, R₂ and R₃ are identical or different one another, C₁₋₁₂alkylene group that may be substituted by hydroxyl group, carboxyl group, phenyl group or amino group, and formula (2)

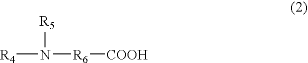

wherein R₄ and R₅ are identical or different each other, hydrogen atom, or C₁₋₁₂alkyl group that may be substituted by hydroxyl group, carboxyl group, phenyl group or amino group, with a proviso that both R₄ and R₅ are not hydrogen at the same time, and R₆ is C₁₋₁₂alkylene group that may be substituted by hydroxyl group, carboxyl group, phenyl group or amino group, and the salts of the amino acid derivatives; and water. The polishing composition can prevent metal contamination, particularly copper contamination in polishing of silicon wafer.

### TECHNICAL FIELD

The present invention relates to a polishing composition that makes possible to prevent efficiently metal pollution on silicon wafers.

### BACKGROUND ART

In general, the production process of semiconductor silicon wafer comprises a slicing step of slicing a single crystal ingot to obtain a wafer in the form of thin disc, a chamfering step of chamfering the periphery of the wafer obtained in the slicing step in order to prevent cracks and break of the wafer, a lapping step of planing the chamfered wafer, an etching step of removing process strain remaining in the chamfered and lapped wafer, a polishing step of mirror-polishing the etched wafer surface and a cleaning step of cleaning the polished wafer to remove polishing agents or foreign materials adhered thereto.

In the above-mentioned polishing step, generally polishing is carried out by using a polishing composition obtained by dispersing fine abrasive of silica in water and further adding chemical polishing accelerators such as inorganic alkali, ammonium salt, amine, or the like.

However, the alkaline silica-containing polishing agent contains trace amounts of metal impurities. The metal impurities contained in the polishing agent include nickel, chromium, iron, copper or the like. These metal impurities easily adhere to the silicon wafer surface in an alkaline solution. The adherent metal impurity, particularly copper has a high diffusion coefficient, and easily diffuses into the crystal of the silicon wafer. It becomes clear that the metal impurities diffused into the crystal cannot be removed by subsequent cleaning, thereby causing deterioration in qualities of the silicon wafer and lowering in characteristics of semiconductor device manufactured by using the wafer.

As a countermeasure against metal contamination on semiconductor wafer resulting from the silica-containing polishing composition, a method by use of a highly purified polishing composition may be mentioned. An example is disclosed in which a semiconductor wafer is polished by using a silica sol containing each iron, chromium, nickel, aluminum and copper in a content less than 1 mass ppb (see, Patent Document 1). However, the high purified polishing composition is generally expensive and therefore cost for polishing presents a problem.

In addition, even when a composition having a high purity is used, in an actual polishing, metal contamination from a polishing pad, a polishing apparatus or piping system is unavoidable. Therefore, even in case where a composition having a high purity is prepared, it is difficult to prevent metal contamination on semiconductor wafer. This has been acknowledged as a problem.

As mentioned above, a polishing composition that is able to efficiently prevent metal contamination by nickel, chromium, iron, copper or the like has been needed.

### Patent Document 1: JP-A-11-214338 (1999)

### DISCLOSURE OF INVENTION

### Problem to be Solved by Invention

An object of the present inventors is to provide a polishing composition for silicon wafer that can prevent metal contamination, particularly copper contamination in order to solve problems that a polishing composition able to efficiently prevent metal contamination by nickel, chromium, iron, copper or the like has been needed.

### Means for Solving Problem

The present invention relates to a polishing composition for silicon wafer comprising silica; a basic compound; at least one compound selected from the group consisting of amino acid derivatives represented by formula (1)

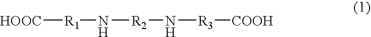

wherein R₁, R₂ and R₃ are identical or different one another, C₁₋₁₂alkylene group that may be substituted by hydroxyl group, carboxyl group, phenyl group or amino group, and formula (2)

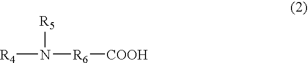

wherein R₄ and R₅ are identical or different each other, hydrogen atom, or C₁₋₁₂alkyl group that may be substituted by hydroxyl group, carboxyl group, phenyl group or amino group, with a proviso that both R₄ and R₅ are not hydrogen at the same time, and R₆ is C₁₋₁₂alkylene group that may be substituted by hydroxyl group, carboxyl group, phenyl group or amino group, and the salts of the amino acid derivatives; and water.

The preferable modes of the polishing composition include the following polishing compositions:
wherein the silica is a silica sol;
wherein the silica has an average particle diameter of 5 to 500 nm, and a concentration of 0.05 to 30 mass % based on the total mass of the polishing composition;
wherein the basic compound has a concentration of 0.01 to 10 mass % based on the total mass of the polishing composition;
wherein the basic compound is at least one selected from the group consisting of inorganic salts of alkali metal, ammonium salts and amines;
wherein the inorganic salt of alkali metal is at least one selected from the group consisting of lithium hydroxide, sodium hydroxide, potassium hydroxide, lithium carbonate, sodium carbonate, potassium carbonate, lithium hydrogen carbonate, sodium hydrogen carbonate and potassium hydrogen carbonate;
wherein the ammonium salt is at least one selected from the group consisting of ammonium hydroxide, ammonium carbonate, ammonium hydrogen carbonate, tetramethylammonium hydroxide, tetraethylammonium hydroxide, tetramethylammonium chloride and tetraethylammonium chloride;
wherein the amine is at least one selected from the group consisting of ethylenediamine, monoethanol amine, 2-(2-aminoethyl)aminoethanol amine and piperazine;
wherein the amino acid derivative has a concentration of 0.001 to 10 mass % based on the total mass of the polishing composition;
wherein the amino acid derivative is at least one selected from the group consisting of ethylenediamine disuccinic acid, trimethylenediamine disuccinic acid, ethylenediamine diglutaric acid, trimethylenediamine diglutaric acid, 2-hydroxy-trimethylenediamine disuccinic acid and 2-hydroxy-trimethylenediamine diglutaric acid, as represented by formula (1), and salts of these acids;
wherein the amino acid derivative is at least one selected from the group consisting of (S, S)-ethylenediamine disuccinic acid, (S, S)-trimethylenediamine disuccinic acid, (S, S)-ethylenediamine diglutaric acid, (S, S)-trimethylenediamine diglutaric acid, (S, S)-2-hydroxy-trimethylenediamine disuccinic acid and (S, S)-2-hydroxy-trimethylenediamine diglutaric acid, as represented by formula (1), and salts of these acids;
wherein the amino acid derivative is at least one selected from the group consisting of aspartic acid-N-acetic acid, aspartic acid-N,N-diacetic acid, aspartic acid-N-propionic acid, iminodisuccinic acid, glutamic acid-N,N-diacetic acid, N-methyliminodiacetic acid, α-alanine-N,N-diacetic acid, β-alanine-N,N-diacetic acid, serine-N,N-diacetic acid, isoserine-N,N-diacetic acid and phenylalanine-N,N-diacetic acid, as represented by formula (2), and salts of these acids;
wherein the amino acid derivative is at least one selected from the group consisting of (S)-aspartic acid-N-acetic acid, (S)-aspartic acid-N,N-diacetic acid, (S)-aspartic acid-N-propionic acid, (S,S)-iminodisuccinic acid, (S,R)-iminodisuccinic acid, (S)-glutamic acid-N,N-diacetic acid, (S)-α-alanine-N,N-diacetic acid, (S)-serine-N,N-diacetic acid and (S)-isoserine-N,N-diacetic acid, as represented by formula (2), and salts of these acids; and
wherein the salt of the amino acid derivative represented by formula (1) and (2) is an alkali metal salt, an ammonium salt or an amine salt.

### Effect of Invention

According to the present invention, it was found that the addition of at least one compound selected from the amino acid derivatives represented by formula (1) and (2) and the salts thereof to a silica-containing polishing agent exerts an effect Of inhibiting metal contamination, particularly copper contamination into silicon wafers and on the surface thereof while maintaining a high removal rate. In particular, as the polishing composition exerts an effect also for amines, copper contamination can be inhibited while maintaining a high removal rate. Further, as it is not required to increase the purity of the polishing agent, metal contamination can be inhibited in a low cost.

### BEST MODE FOR CARRYING OUT THE INVENTION

The embodiments of the present invention will be described.

In the present invention, silica (silicon dioxide) is used as an abrasive grain. Although it is known that the processing by use of ceria and alumina as polishing agents for grinding or polishing silicon wafers is effective, silica is suitable as a polishing agent for the polishing composition of the present invention. In addition, as silica, silica sol, fumed silica, precipitated silica or silica in other form is known, and any silica among them can be used in the present invention. In particular, in order to polish semiconductor surface in a high precision, it is preferable to use a silica sol (a stable dispersion of silica particles) containing particles having homogeneous particle diameter and an average particle diameter of colloidal dimension (nano dimension).

The silica sol used in the present invention may be any silica sol obtained according to any known production methods. The production method is not specifically limited. As the production method of silica sol, JP-B46-20137 (1971) discloses a production method of concentrated aqueous silica sol comprising adding an aqueous colloidal solution of active silicic acid in an alkali silicate aqueous solution while evaporating off water at a temperature of 90° C. or more. JP-A-60-251119 (1985) discloses a production method of silica sol having large particle diameter comprising adding an aqueous colloidal solution of active silicic acid in an alkali silicate aqueous solution to prepare a silica sol in which silica particles of 40 to 120 nm are dispersed in a disperse medium, then maturing it after adding an acid, and further concentrating through a fine porous membrane. JP-B4636 (1974) discloses a production method of stable silica sol having arbitrary and desired particle diameter comprising heating an aqueous silica sol under a specific condition. In addition, JP-B-41-3369 (1966) discloses a production method of highly purified silica sol comprising subjecting an alkali silicate aqueous solution to de-alkalization process with acid type cation exchange resin to obtain a silicate sol, adding nitric acid in the sol to adjust pH 1.2, maturing at ordinary temperature for 72 hours, then passing through an acid type strong acid cation exchange resin and an hydroxy type anion exchange resin, immediately adding sodium hydroxide therein to adjust pH 8.0, and concentrating with evaporation under vacuum at 80° C. while maintaining a constant level of solution. JP-A-63-285112 (1988) discloses a production method of silica sol having high purity and large particle diameter comprising subjecting an alkali silicate aqueous solution to de-alkalization process with acid type cation exchange resin to obtain a silicate sol, adding a strong acid in the sol to adjust pH 0 to 2, maturing, then passing through an acid type strong acid cation exchange resin and an hydroxy type anion exchange resin, adding a highly purified alkali metal hydroxide aqueous solution therein to obtain a stabilized silica aqueous colloid having a high purity adjusted to pH 7 to 8, adding the stabilized silica aqueous colloid having a high purity to a heating stabilized silica aqueous colloid having a high purity at a temperature of 90 to 120° C. to a silica sol, maturing the silica sol after adding an acid therein, and further concentrating through a fine porous membrane. Further, JP-A63-74911 (1988). discloses a production method of finely spherical silica comprising hydrolyzing an alkoxy silane in a water-alcohol mixed solution containing an alkaline catalyst.

In the meanwhile, the average particle diameter of silica is an average particle diameter calculated from specific surface area measured by nitrogen adsorption method (BET method). The average particle diameter is generally 3 to 1000 nm, preferably 5 to 500 nm, most preferably 10 to 500 nm, which falls into colloidal dimension. Further, the mass proportion of the silica added is generally 0.05 to 30 mass %, preferably 0.1 to 10 mass %, more preferably 1 to 5 mass % based on the total mass of the polishing composition. In case where the proportion is 0.05 mass % or less, sufficient removal rate is not obtained. On the other hand, in case where it is 30 mass % or more, it cannot be expected to improve removal rate.

The basic compounds used in the present invention are inorganic salts of alkali metal, ammonium salts or amines. The salts of alkali metal include hydroxides or carbonate of alkali metals and the like. Specifically, lithium hydroxide, sodium hydroxide, potassium hydroxide, lithium carbonate, sodium carbonate, potassium carbonate, lithium hydrogen carbonate, sodium hydrogen carbonate, potassium hydrogen carbonate and the like are preferable. Particularly, sodium hydroxide, potassium hydroxide, sodium carbonate, potassium carbonate and the like are more preferable.

The ammonium salt is preferably ammonium hydroxide, ammonium carbonate, ammonium hydrogen carbonate, quaternary ammonium salts and the like, particularly ammonium hydroxide and quaternary ammonium salts are more preferable. Specific examples of the quaternary ammonium salts are tetramethylammonium hydroxide, tetraethylammonium hydroxide, tetramethylammonium chloride, tetraethylammonium chloride and the like, particularly tetramethylammonium hydroxide is more preferable.

The amines include ethylenediamine, monoethanol amine, 2-(2-aminoethyl)aminoethanol amine, piperazine and the like. The amines are not limited to these amines, and may contain other amines.

Although the preferable added amount of the basic compound is not absolutely determined as it varies depending on what material is used, it is generally 0.01 to 10 mass % based on the total mass of the polishing composition. In particular, in case where the process accelerator is an alkali metal salt, it is preferably 0.01 to 1.0 mass %, in case where an ammonium salt is used, it is preferably 0.01 to 5 mass %, and in case where an amine is used, it is preferably 0.1 to 10 mass %. When the amount is less than 0.01 mass %, the effect of the process accelerator is not fully exerted. On the other hand, even when added in an amount of 10 mass % or more, it cannot be expected to further improve removal rate. In addition, the above-mentioned basic compounds can be used in a mixture of two or more.

The compounds represented by formula (1) and (2) are chelating agents of amino acid type. The amino acid derivatives used in the present invention are commercially available as chelating agents, and can be easily obtained. In addition, they are excellent in biodegradability compared with aminopolycarboxylic acid such as EDTA, and further useful from viewpoint of waste-water treatment compared with aminopolycarboxylic acid.

The amino acid derivatives include ethylenediamine-N,N′-diacetic acid, ethylenediamine-N,N′-dipropionic acid, ethylenediamine-N,N′-disuccinic acid, ethylenediamine-N,N′-diglutaric acid, trimethylenediamine-N,N′-diacetic acid, trimethylenediamine-N,N′-dipropionic acid, trimethylenediamine-N,N′-disuccinic acid, trimethylenediamine-N,N′-diglutaric acid, 2-hydroxytrimethylenediamine-N,N′-diacetic acid, 2-hydroxytrimethylenediamine-N,N′-dipropionic acid, 2-hydroxytrimethylenediamine-N,N′-disuccic acid, 2-hydroxytrimethylenediamine-N,N′-diglutaric acid, ethylenediamine-N-acetic acid-N′-succinic acid, ethylenediamine-N-acetic acid-N′-propionic acid, ethylenediamine-N-propionic acid-N′-succinic acid, ethylenediamine-N-acetic acid-N′-glutaric acid, trimethylenediamine-N-acetic acid-N′-succinic acid, trimethylenediamine-N-acetic acid-N′-propionic acid, trimethylenediamine-N-propionic acid-N′-succinic acid, trimethylenediamine-N-succinic acid-N′-glutaric acid, 2-hydroxytrimethylenediamine-N-acetic acid-N′-succinic acid, 2-hydroxytrimethylenediamine-N-acetic acid-N′-propionic acid, 2-hydroxytrimethylenediamine-N-acetic acid-N′-succinic acid, as represented by formula (1), and salts of these acids. Preferable the amino acid derivatives include ethylenediamine disuccinic acid, trimethylenediamine disuccinic acid, ethylenediamine diglutaric acid, trimethylenediamine diglutaric acid, 2-hydroxy-trimethylenediamine disuccinic acid and 2-hydroxy-trimethylenediamine diglutaric acid, and salts of these acids. These compounds can be used in a mixture of two or more.

In case where the amino acid derivatives contain one or plural asymmetric carbons in the formula (1), plural optical isomers may be present. Any isomers can be used alone or in an admixture, but amino acid derivatives containing S-form asymmetric carbon that are excellent in biodegradability are preferable. Particularly, are preferable the amino acid derivatives in which all asymmetric carbons are in S-form and which are more excellent in biodegradability. They include (S, S)-ethylenediamine disuccinic acid, (S, S)-trimethylenediamine disuccinic acid, (S, S)-ethylenediamine diglutaric acid, (S, S)-trimethylenediamine diglutaric acid, (S, S)-2-hydroxy-trimethylenediamine disuccinic acid, and (S, S)-2-hydroxy-trimethylenediamine diglutaric acid, and salts of these acids. These compounds call be used in a mixture of two or more.

The amino acid derivatives also include aspartic acid-N-acetic acid, aspartic acid-N,N-diacetic acid, aspartic acid-N-propionic acid, iminodisuccinic acid, glutamic acid-N,N-diacetic acid, N-methyliminodiacetic acid, α-alanine-N,N-diacetic acid, β-alanine-N,N-diacetic acid, serine-N,N-diacetic acid, isoserine-N,N-diacetic acid and phenylalanine-N,N-diacetic acid, as represented by formula (2), and salts of these acids. These compounds can be used in a mixture of two or more.

In case where the amino acid derivatives contain one or plural asymmetric carbons in the formula (2), plural optical isomers may be present. Any isomers can be used alone or in an admixture, but amino acid derivatives containing S-form asymmetric carbon that are excellent in biodegradability are preferable. Particularly, are preferable the amino acid derivatives in which all asymmetric carbons are in S-form and which are more excellent in biodegradability. They include (S)-aspartic acid-N-acetic acid, (S)-aspartic acid-N,N-diacetic acid, (S)-aspartic acid-N-propionic acid, (S,S)-iminodisuccinic acid, (S,R)-iminodisuccinic acid, (S)-glutamic acid-N,N-diacetic acid, (S)-α-alanine-N,N-diacetic acid, (S)-serine-N,N-diacetic acid and (S)-isoserine-N,N-diacetic acid, and salts of these acids. These compounds can be used in a mixture of two or more.

Although the added amount of the amino acid derivative represented by formula (1) and (2) varies depending on the kind of the derivative used and is not specifically limited so long as the effect of the present invention is exerted, it is 0.001 to 10 mass %, preferably 0.01 to 10 mass %, more preferably 0.1 to 5 mass % based on the total mass of the polishing composition. In case where the amount is less than 0.001 mass %, the effect by the addition is not fully exerted and therefore the effect of preventing metal contamination is not fully exerted in many cases. On the other hand, even when added in an amount over 10 mass %, it cannot be expected to exert further effect by the addition.

### EXAMPLES

Hereinafter, the examples of the present invention will be described. In the meanwhile, the present invention is not limited to the examples

### Example 1

A silica sol [silica concentration: 3.0 mass %, particle diameter: 45 nm, copper (hereinafter referred to as Cu) concentration: 5 mass ppb, adjusted to pH 9 with sodium hydroxide (hereinafter referred to as NaOH)] was prepared as a base material of polishing composition (polishing solution), and was compulsorily contaminated with copper by adding a standard copper solution for atomic absorption spectrometry analysis (copper nitrate solution having Cu concentration of 1000 mass ppm) in the silica sol so as to have Cu concentration of 10 mass ppb.

In the silica sol contaminated with copper as mentioned above, NaOH and (S,S)-ethylenediamine disuccinic acid (hereinafter referred to as EDDS) were added so as to have a concentration of 0.1 mass % and 0.1 mass %, respectively to prepare a polishing solution.

P type (100) semiconductor silicon wafer was polished for 30 minutes by using the polishing solution. For polishing, a commercially available one-side polishing machine was used.

The wafer was subjected to a known SC1 cleaning (treatment of dipping in a cleaning solution (SC1 solution) of ammonia:hydrogen peroxide:water mixed in a ratio of 1:1 to 2:5 to 7 at 75 to 85° C. for 10 to 20 minutes) and SC2 cleaning (treatment of dipping in a cleaning solution (SC2 solution) of hydrochloric acid:hydrogen peroxide:water mixed in a ratio of 1:1 to 2:5 to 7 at 75 to 85° C. for 10 to 20 minutes) to remove impurities on the wafer surface, then the cleaned wafer was subjected to heat treatment at 650° C. for 20 minutes, copper on the wafer surface was recovered by adding dropwise HF/H₂O₂, and metal impurities in the recovered solution was subjected to quantitative analysis with Inductively Coupled Plasma Mass Spectrometry (hereinafter referred to as ICP-MS).

### Example 2

A polishing solution was prepared by adding in the silica sol contaminated with copper similar to that in Example 1, NaOH and EDDS so as to have a concentration of 0.1 mass % and 0.05 mass %, respectively. Polishing was carried out for 30 minutes by using the polishing solution, and quantitative analysis of copper was carried out.

### Example 3

A polishing solution was prepared by adding in the silica sol contaminated with copper similar to that in Example 1, NaOH and EDDS so as to have a concentration of 0.1 mass % and 0.5 mass %, respectively. Polishing was carried out for 30 minutes by using the polishing solution, and quantitative analysis of copper was carried out.

### Example 4

A polishing solution was prepared by adding in the silica sol contaminated with copper similar to that in Example 1, piperazine and EDDS so as to have a concentration of 0.1 mass % and 0.1 mass %, respectively. Polishing was carried out for 30 minutes by using the polishing solution, and quantitative analysis of copper was carried out.

### Example 5

A polishing solution was prepared by adding in the silica sol contaminated with copper similar to that in Example 1, piperazine and EDDS so as to have a concentration of 0.5 mass % and 0.1 mass %, respectively. Polishing was carried out for 30 minutes by using the polishing solution, and quantitative analysis of copper was carried out.

### Example 6

A polishing solution was prepared by adding in the silica sol contaminated with copper similar to that in Example 1, piperazine and EDDS so as to have a concentration of 1.5 mass % and 0.1 mass %, respectively. Polishing was carried out for 30 minutes by using the polishing solution, and quantitative analysis of copper was carried out.

### Example 7

A polishing solution was prepared by adding in the silica sol contaminated with copper similar to that in Example 1, tetramethylammonium hydroxide (hereinafter referred to as TMAH) and EDDS so as to have a concentration of 0.1 mass % and 0.1 mass %, respectively. Polishing was carried out for 30 minutes by using the polishing solution, and quantitative analysis of copper was carried out.

### Example 8

A polishing solution was prepared by adding in the silica sol contaminated with copper similar to that in Example 1, NaOH and (S)-glutamic acid-N,N-diacetic acid (hereinafter referred to as GLDA) so as to have a concentration of 0.1 mass % and 0.1 mass %, respectively. Polishing was carried out for 30 minutes by using the polishing solution, and quantitative analysis of copper was carried out.

### Example 9

A polishing solution was prepared by adding in the silica sol contaminated with copper similar to that in Example 1, piperazine and GLDA so as to have a concentration of 0.5 mass % and 0.1 mass %, respectively. Polishing was carried out for 30 minutes by using the polishing solution, and quantitative analysis of copper was carried out.

### Example 10

A polishing solution was prepared by adding in the silica sol contaminated with copper similar to that in Example 1, TMAH and GLDA so as to have a concentration of 0.1 mass % and 0.1 mass %, respectively. Polishing was carried out for 30 minutes by using the polishing solution, and quantitative analysis of copper was carried out.

### Example 11

A polishing solution was prepared by adding in the silica sol contaminated with copper similar to that in Example 1, NaOH and (S)-aspartic acid-N,N-diacetic acid (hereinafter referred to as ASDA) so as to have a concentration of 0.1 mass % and 0.1 mass %, respectively. Polishing was carried out for 30 minutes by using the polishing solution, and quantitative analysis of copper was carried out.

### Example 12

A polishing solution was prepared by adding in the silica sol contaminated with copper similar to that in Example 1, piperazine and ASDA so as to have a concentration of 0.5 mass % and 0.1 mass %, respectively. Polishing was carried out for 30 minutes by using the polishing solution, and quantitative analysis of copper was carried out.

### Example 13

A polishing solution was prepared by adding in the silica sol contaminated with copper similar to that in Example 1, TMAH and ASDA so as to have a concentration of 0.1 mass % and 0.1 mass %, respectively. Polishing was carried out for 30 minutes by using the polishing solution, and quantitative analysis of copper was carried out.

### Example 14

A polishing solution was prepared by adding in the silica sol as a base material similar to that in Example 1 that was not contaminated with copper, NaOH and EDDS so as to have a concentration of 0.1 mass % and 0.1 mass %, respectively. Polishing was carried out for 30 minutes by using the polishing solution, and quantitative analysis of copper was carried out.

### Example 15

In a silica sol [silica concentration: 3.0 mass %, particle diameter: 45 nm, Cu concentration: 0.5 mass ppb, adjusted to pH 9 with NaOH] as a base material of polishing composition (polishing solution), NaOH and EDDS were added so as to have a concentration of 0.1 mass % and 0.1 mass %, respectively. Polishing was carried out for 30 minutes by using the polishing solution, and quantitative analysis of copper was carried out.

### Comparative Example 1

A polishing solution was prepared by adding in the silica sol as a base material similar to that in Example 1 that was not contaminated with copper, NaOH so as to have a concentration of 0.1 mass %. Polishing was carried out for 30 minutes by using the polishing solution, and quantitative analysis of copper was carried out.

### Comparative Example 2

A polishing solution was prepared by adding in the silica sol as a base material similar to that in Example 1 that was not contaminated with copper, piperazine so as to have a concentration of 0.5 mass %. Polishing was carried out for 30 minutes by using the polishing solution, and quantitative analysis of copper was carried out.

### Comparative Example 3

A polishing solution was prepared by adding in the silica sol as a base material similar to that in Example 1 that was not contaminated with copper, TMAH so as to have a concentration of 0.1 mass %. Polishing was carried out for 30 minutes by using the polishing solution, and quantitative analysis of copper was carried out.

### Comparative Example 4

A polishing solution was prepared by adding in the silica sol contaminated with copper similar to that in Example 1, NaOH so as to have a concentration of 0.1 mass %. Polishing was carried out for 30 minutes by using the polishing solution, and quantitative analysis of copper was carried out.

### Comparative Example 5

A polishing solution was prepared by adding in the silica sol contaminated with copper similar to that in Example 1, piperazine so as to have a concentration of 0.5 mass %. Polishing was carried out for 30 minutes by using the polishing solution, and quantitative analysis of copper was carried out.

### Comparative Example 6

A polishing solution was prepared by adding in the silica sol contaminated with copper similar to that in Example 1, TMAH so as to have a concentration of 0.1 mass %. Polishing was carried out for 30 minutes by using the polishing solution, and quantitative analysis of copper was carried out.

### Comparative Example 7

A polishing solution was prepared by adding in the silica sol as a base material similar to that in Example 15, NaOH so as to have a concentration of 0.1 mass %. Polishing was carried out for 30 minutes by using the polishing solution, and quantitative analysis of copper was carried out.

TABLE 1

| | | Basic material | | Amino acid derivative | | | | |
|---|---|---|---|---|---|---|---|---|
| | Silica | | Added | | Added | Cu compulsory | Cu concentration | Removal |
| | concentration | | amount | | amount | contamination | after polishing | rate |
| | (mass %) | Kind | (mass %) | Kind | (mass %) | (mass ppb) | (atoms/cm²) | (μm/min) |
| Example 1 | 3.0 | NaOH | 0.1 | EDDS | 0.1 | 10 | 3.4 × 10⁹ | 0.30 |
| Example 2 | 3.0 | NaOH | 0.1 | EDDS | 0.05 | 10 | 4.0 × 10⁹ | 0.29 |
| Example 3 | 3.0 | NaOH | 0.1 | EDDS | 0.5 | 10 | 3.2 × 10⁹ | 0.30 |
| Example 4 | 3.0 | Piperazine | 0.1 | EDDS | 0.1 | 10 | 5.4 × 10⁹ | 0.40 |
| Example 5 | 3.0 | Piperazine | 0.5 | EDDS | 0.1 | 10 | 5.6 × 10⁹ | 0.51 |
| Example 6 | 3.0 | Piperazine | 1.5 | EDDS | 0.1 | 10 | 5.9 × 10⁹ | 0.56 |
| Example 7 | 3.0 | TMAH | 0.1 | EDDS | 0.1 | 10 | 2.9 × 10⁹ | 0.37 |
| Example 8 | 3.0 | NaOH | 0.1 | GLDA | 0.1 | 10 | 3.7 × 10⁹ | 0.30 |
| Example 9 | 3.0 | Piperazine | 0.5 | GLDA | 0.1 | 10 | 6.2 × 10⁹ | 0.54 |
| Example 10 | 3.0 | TMAH | 0.1 | GLDA | 0.1 | 10 | 3.5 × 10⁹ | 0.35 |
| Example 11 | 3.0 | NaOH | 0.1 | ASDA | 0.1 | 10 | 3.6 × 10⁹ | 0.31 |
| Example 12 | 3.0 | Piperazine | 0.5 | ASDA | 0.1 | 10 | 5.9 × 10⁹ | 0.52 |
| Example 13 | 3.0 | TMAH | 0.1 | ASDA | 0.1 | 10 | 3.2 × 10⁹ | 0.36 |
| Example 14 | 3.0 | NaOH | 0.1 | EDDS | 0.1 | None | 3.4 × 10⁹ | 0.30 |
| Example 15 | 3.0 | NaOH | 0.1 | EDDS | 0.1 | None | 2.5 × 10⁹ | 0.31 |

TABLE 2

| | | Basic material | | Amino acid derivative | | | | |
|---|---|---|---|---|---|---|---|---|
| | Silica | | Added | | Added | Cu compulsory | Cu Concentration | Removal |
| | concentration | | amount | | amount | contamination | after polishing | rate |
| | (mass %) | Kind | (mass %) | Kind | (mass %) | (mass ppb) | (atoms/cm²) | (μm/min) |
| Comparative | 3.0 | NaOH | 0.1 | None | 0 | None | 3.8 × 10¹⁰ | 0.29 |
| Example 1 | | | | | | | | |
| Comparative | 3.0 | Piperazine | 0.5 | None | 0 | None | 4.5 × 10¹⁰ | 0.54 |
| Example 2 | | | | | | | | |
| Comparative | 3.0 | TMAH | 0.1 | None | 0 | None | 3.7 × 10¹⁰ | 0.35 |
| Example 3 | | | | | | | | |
| Comparative | 3.0 | NaOH | 0.1 | None | 0 | 10 | 2.5 × 10¹¹ | 0.30 |
| Example 4 | | | | | | | | |
| Comparative | 3.0 | Piperazine | 0.5 | None | 0 | 10 | 3.2 × 10¹¹ | 0.57 |
| Example 5 | | | | | | | | |
| Comparative | 3.0 | TMAH | 0.1 | None | 0 | 10 | 9.8 × 10¹⁰ | 0.35 |
| Example 6 | | | | | | | | |
| Comparative | 3.0 | NaOH | 0.1 | None | 0 | None | 9.0 × 10⁹ | 0.30 |
| Example 7 | | | | | | | | |

The measurement results of copper contamination and the removal rate on polishing wafers are shown in Tables 1 and 2. In case where no amino acid derivative was added as shown in Comparative Examples 1 to 3, contamination of the level of 10¹⁰ atom/cm² was found even when no compulsory contamination was carried out, and copper contamination was further increased when compulsory contamination was carried out as shown in Comparative Example 4 to 6. As shown in Comparative Example 7, even when a silica sol containing Cu in a small amount was used, copper contamination in silicon wafer was not able to be fully inhibited. Therefore, when the amino acid derivative represented by formula (1) and (2) was not added, copper contamination was unavoidable.

Copper contamination of silicon wafer after polishing was able to be inhibited in case where EDDS was added as shown in Example 14 compared with cases where no amino acid derivative was added. In addition, inhibition against copper contamination in silicon wafer was able to be further improved by using a silica sol containing Cu in a small amount as shown in Example 15.

Even when compulsory copper contamination was carried out as shown in Examples 1, 5 or 7, copper contamination of silicon wafer after polishing was able to be inhibited to the level of 10⁹ atom/cm² regardless of the kind of basic compounds compared with cases where no amino acid derivative was added. In addition, in also cases where the kind of amino acid derivatives was changed from EDDS to GLDA or ASDA, a similar effect inhibiting copper contamination was found as shown in Examples 8 to 13.

Even when amino acid derivatives were added as shown in Examples 1, 5 or 7 to 15, removal rate comparable to Comparative Example 4 to 6 was obtained. That is, any influence on removal rate by the addition of amino acid derivative was not found. In addition, even when basic compounds were added as shown in Examples 4 to 6, any difference in the level of copper contamination was not found, and it was found to fully have an effect of inhibiting copper contamination.

As mentioned above, according to the present invention, it was found to be able to inhibit metal contamination, particularly copper contamination while maintaining a suitable removal rate by adding the amino acid derivative represented by formula (1) and (2) to silica-containing polishing agents. In particular, as the polishing composition exerts an effect also for amines, copper contamination can be inhibited while maintaining a high removal rate. Further, as the polishing composition of the present invention is not required to purify a polishing agent to a high purity, it can inhibit metal contamination in a low cost.

1. A polishing composition for silicon wafer comprising
silica,
a basic compound,
at least one compound selected from the group consisting of amino acid derivatives represented by formula (1) 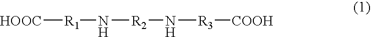
wherein R₁, R₂ and R₃ are identical or different one another, C₁₋₁₂alkylene group that may be substituted by hydroxyl group, carboxyl group, phenyl group or amino group, and formula (2) 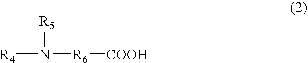
wherein R₄ and R₅ are identical or different each other, hydrogen atom, or C₁₋₁₂alkyl group that may be substituted by hydroxyl group, carboxyl group, phenyl group or amino group, with a proviso that both R₄ and R₅ are not hydrogen at the same time, and R₆ is C₁₋₁₂alkylene group that may be substituted by hydroxyl group, carboxyl group, phenyl group or amino group, and the salts of the amino acid derivatives, and water.

2. The polishing composition for silicon wafer according to claim 1, wherein the silica is a silica sol.

3. The polishing composition for silicon wafer according to claim l, wherein the silica has an average particle diameter of 5 to 500 nm, and a concentration of 0.05 to 30 mass % based on the total mass of the polishing composition.

4. The polishing composition for silicon wafer according to claim 1, wherein the basic compound has a concentration of 0.01 to 10 mass % based on the total mass of the polishing composition.

5. The polishing composition for silicon wafer according to claim 1, wherein the basic compound is at least one selected from the group consisting of inorganic salts of alkali metal, ammonium salts and amines.

6. The polishing composition for silicon wafer according to claim 5, wherein the inorganic salt of alkali metal is at least one selected from the group consisting of lithium hydroxide, sodium hydroxide, potassium hydroxide, lithium carbonate, sodium carbonate, potassium carbonate, lithium hydrogen carbonate, sodium hydrogen carbonate and potassium hydrogen carbonate.

7. The polishing composition for silicon wafer according to claim 5, wherein the ammonium salt is at least one selected from the group consisting of ammonium hydroxide, ammonium carbonate, ammonium hydrogen carbonate, tetramethylammonium hydroxide, tetraethylammonium hydroxide, tetramethylammonium chloride and tetraethylammonium chloride.

8. The polishing composition for silicon wafer according to claim 5, wherein the amine is at least one selected from the group consisting of ethylenediamine, monoethanol amine, 2-(2-aminoethyl)aminoethanol amine and piperazine.

9. The polishing composition for silicon wafer according to claim 1, wherein the amino acid derivative has a concentration of 0.001 to 10 mass % based on the total mass of the polishing composition.

10. The polishing composition for silicon wafer according to claim 1, wherein the amino acid derivative is at least one selected from the group consisting of ethylenediamine disuccinic acid, trimethylenediamine disuccinic acid, ethylenediamine diglutaric acid, trimethylenediamine diglutaric acid, 2-hydroxy-trimethylenediamine disuccinic acid and 2-hydroxy-trimethylenediamine diglutaric acid, as represented by formula (1), and salts of these acids.

11. The polishing composition for silicon wafer according to claim 1, wherein the amino acid derivative is at least one selected from the group consisting of (S, S)-ethylenediamine disuccinic acid, (S, S)-trimethylenediamine disuccinic acid, (S, S)-ethylenediamine diglutaric acid, (S, S)-trimethylenediamine diglutaric acid, (S, S)-2-hydroxy-trimethylenediamine disuccinic acid and (S, S)-2-hydroxy-trimethylenediamine diglutaric acid, as represented by formula (1), and salts of these acids.

12. The polishing composition for silicon wafer according to claim 1, wherein the amino acid derivative is at least one selected from the group consisting of aspartic acid-N-acetic acid, aspartic acid-N,N-diacetic acid, aspartic acid-N-propionic acid, iminodisuccinic acid, glutamic acid-N,N-diacetic acid, N-methyliminodiacetic acid, (α-alanine-N,N-diacetic acid, β-alanine-N,N-diacetic acid, serine-N,N-diacetic acid, isoserine-N,N-diacetic acid and phenylalanine-N,N-diacetic acid, as represented by formula (2), and salts of these acids.

13. The polishing composition for silicon wafer according to claim 1, wherein the amino acid derivative is at least one selected from the group consisting of (S)-aspartic acid-N-acetic acid, (S)-aspartic acid-N,N-diacetic acid, (S)-aspartic acid-N-propionic acid, (S,S)-iminodisuccinic acid, (S,R)-iminodisuccinic acid, (S)-glutamic acid-N,N-diacetic acid, (S)-α-alanine-N,N-diacetic acid, (S)-serine-N,N-diacetic acid and (S)-isoserine-N,N-diacetic acid, as represented by formula (2), and salts of these acids.

14. The polishing composition for silicon wafer according to claim 1, wherein the salt of the amino acid derivative, represented by formula (1) and (2) is an alkali metal salt, an ammonium salt or an amine salt.
